(19) United States
(12) Patent Application Publication
(10) Pub. No.: US 2009/0196949 A1
(43) Pub. Date: Aug. 6, 2009

(54) RUMINANT FEED

(75) Inventor: Thomas Stephen Winowiski, Mosinee, WI (US)

Correspondence Address: IPLM GROUP, P.A., POST OFFICE BOX 18455, MINNEAPOLIS, MN, 55418, US

(73) Assignee: LignoTech USA, Inc.

(21) Appl. No.: 12/234,421

(22) Filed: Sep. 19, 2008

Related U.S. Application Data
(60) Provisional application No. 61/026,335, filed on Feb. 5, 2008.

(51) Int. Cl. A23K 1/16; A23K 1/06; A23K 1/14

(52) U.S. Cl. 426/2; 426/635; 426/656; 426/630; 426/72

(57) ABSTRACT

One or more partial oxidation products of glycerol are reacted with a protein-containing fodder or fodder precursor to provide a rumen undegradable protein-containing ruminant feed product. The reaction may take place more rapidly, or at lower addition levels, or at lower temperatures than is the case when reacting spent sulfite liquor with protein-containing fodder. The partial oxidation products conveniently may be provided as a glycerose liquor containing glycerose and other side products of a glycerol oxidation reaction. The glycerose liquor may in turn conveniently be prepared by partially oxidizing biodiesel-derived glycerol.

### CROSS-REFERENCE TO RELATED APPLICATION

This application claims priority from U.S. provisional patent application Ser. No. 61/026,335 filed Feb. 5, 2008, the disclosure of which is incorporated herein by reference.

### FIELD

This invention relates to ruminant animal feeds.

### BACKGROUND

U.S. Pat. Nos. 4,957,748, 5,023,091 and 5,064,665 describe ruminant feeds and feed supplements made by mixing and heating a feed protein and a reducing carbohydrate to cause non-enzymatic browning. The resulting feed product contains rumen undegradable protein (RUP) which may also be referred to as bypass protected protein or rumen-protected protein. RUP resists degradation while in the ruminal tract but remains digestible when in the post-rumen tract. U.S. Pat. No. 5,789,001 describes ruminant feeds and feed supplements made by mixing and heating an oilseed meat and a reducing carbohydrate to cause non-enzymatic browning. The ruminant feeds in these U.S. patents may be made by reacting spent sulfite liquor with various soybean feed ingredients, in a batch or continuous heating process. The reaction may for example employ about 3-10% spent sulfite liquors based on the weight of the soybean feed ingredients with heating or hot standing times of about 30 minutes or more. Spent sulfite liquor, a byproduct of paper making, is said to be a preferred reducing carbohydrate source. Glucose, fructose, mannose, lactose, ribose, hemicellulose extracts and their hydrolysates, molasses and its hydrolysate and corn products and their hydrolysates are also said to be suitable reducing carbohydrates.

U.S. Pat. No. 3,619,200 and U.K. Patent Application No. 2 131 273 A describe the treatment of animal feeds with formaldehyde to decrease digestion in the rumen. Although formaldehyde is approved by the U.S. Food & Drug Administration for use as a biocide in feeds, it is not approved for treating ruminant feed to reduce microbial degradation in the rumen.

### SUMMARY OF THE INVENTION

The present invention provides, in one aspect, a method for making an RUP-containing feed product, which method comprises the step of combining at least one partial oxidation product of glycerol with a protein-containing fodder or fodder precursor. In a preferred embodiment glycerose (viz., glyceraldehyde) is employed as the partial oxidation product. In a further preferred embodiment the partial oxidation product and fodder or fodder precursor are mixed, or mixed and heated, to facilitate feed product formation. The partial oxidation products may be in purified or impure form, and may conveniently be provided as a glycerose liquor containing glycerose and other side products of a glycerol oxidation reaction. The glycerose liquor may in turn conveniently be prepared by subjecting a starting solution containing pure or impure glycerol to an oxidation reaction. Glycerose appears to be highly reactive towards protein-containing fodder. Other species in the glycerose liquor may be reactive towards protein-containing fodder as well. The reaction may take place more rapidly, or at lower addition levels, or at lower temperatures than is the case when reacting spent sulfite liquor with protein-containing fodder.

The invention provides in another aspect a ruminant feed product comprising an RUP-containing reaction product of one or more partial oxidation products of glycerol and a protein-containing fodder or fodder precursor.

The invention provides in yet another aspect a method for feeding a ruminant, which method comprises the step of feeding to the ruminant an RUP-containing reaction product of one or more partial oxidation products of glycerol and a protein-containing fodder or fodder precursor.

Compared to current processes for making RUP-containing ruminant feeds, the disclosed feed manufacturing processes may provide one or more important advantages. For example, relatively low amounts of the disclosed partial oxidation product may be employed, thereby lessening the extent of protein dilution. The reactant heating times or heating temperatures may be lowered with a consequent reduction in heat damage to protein and lysine degradation in the finished feed product, a consequent increase in manufacturing plant throughput, or a consequent reduction in manufacturing plant energy costs. When the partial oxidation product is obtained by oxidizing crude glycerin from biodiesel manufacture, the disclosed feed manufacturing process provides a valuable use for a surplus biodiesel waste byproduct which might otherwise be incinerated or used for low-value alternative uses.

### BRIEF DESCRIPTION OF THE DRAWING

FIG. 1 is a schematic view of one embodiment of the disclosed feed manufacturing process.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. Thus a reaction mixture that contains “a” protein-containing fodder may include “one or more” protein-containing fodders.

The term “crude glycerin” means an impure byproduct of biodiesel manufacturing, containing for example about 45 to about 85 wt. % glycerol.

The term “fodder” means a material suitable for feeding ruminant animals.

The term “fodder precursor” means a material (for example, crushed seeds, extracts, syrups, leaves, grasses, stalks or roots) that is subjected to one or more further processing steps or combined with one or more other materials to form a fodder product.

The term “glycerose liquor” means a liquid mixture containing glycerose and other side products of a glycerol oxidation reaction.

The term “impure”, when used with respect to a sample containing a desired chemical, means that the sample contains less than 85 wt. % of the desired chemical.

The term “partial oxidation product”, when used with respect to a material made from glycerol, means a partially but incompletely oxidized reaction product of glycerol and an oxidizing agent.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “ruminally inert”, when used with respect to a protein or lipid, means that the interaction of the protein or lipid with rumen bacteria is reduced or prevented, and the protein or lipid is rendered available for digestion and absorption in the post-rumen gastrointestinal tract of a ruminant.

The recitation of a numerical range using endpoints includes all numbers subsumed within that range (e.g., 1 to 5 includes 1, 1.5, 2, 2.75, 3, 3.80, 4, 5, etc.). The recitation of sets of upper and lower endpoints (e.g., at least 1, at least 2, at least 3, and less than 10, less than 5 and less than 4) includes all ranges that may be formed from such endpoints (e.g., 1 to 10, 1 to 5, 2 to 10, 2 to 5, etc.).

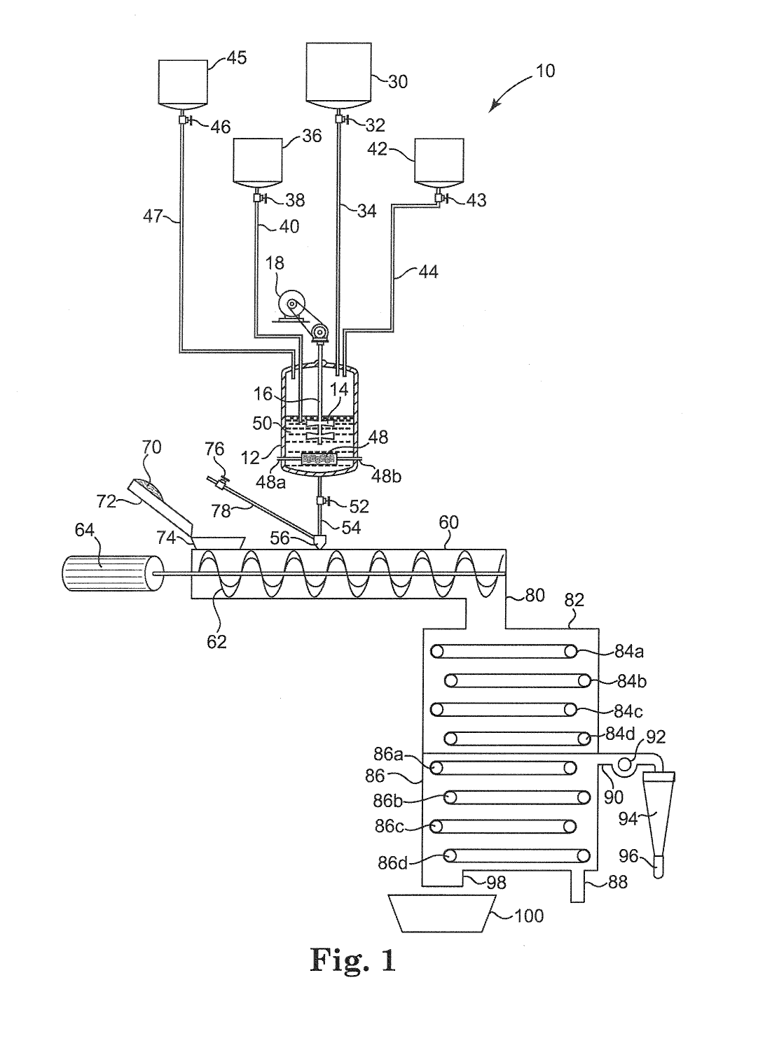

FIG. 1 shows an exemplary schematic view of one embodiment of the disclosed feed manufacturing process. Apparatus 10 includes an oxidation reactor 12 for making glycerose in the form of a glycerose liquor. Further details regarding glycerose manufacture from biodiesel-derived crude glycerin may be found in copending U.S. Patent Application No. (Attorney Docket No. 250-P-224USU1) filed even date herewith and entitled GLYCEROSE SYNTHESIS, the disclosure of which is incorporated herein by reference. Reactor 12 is equipped with an impeller 14 mounted on shaft 16 and driven by a motor 18. Glycerol (desirably obtained in concentrated solution form as a byproduct of biodiesel production) stored in vessel 30 is regulated by valve 32 and fed to reactor 12 through conduit 34. An oxidizer such as hydrogen peroxide stored in vessel 36 may be regulated by valve 38 and fed to reactor 12 through conduit 40. A catalyst solution such as a solution of ferrous sulfate stored in vessel 42 may be regulated by valve 43 and fed to reactor 12 through conduit 44. A chelating agent solution such as a solution of ethylene diamine tetraacetic acid (EDTA) stored in vessel 45 may be regulated by valve 46 and fed to reactor 12 through conduit 47. The reaction is generally exothermic, and a heat exchanger 48 supplied with inlet and outlet lines 48a and 48b connected to a suitable coolant source (not shown in FIG. 1) may be used to control the temperature in reactor 12. At the completion of the oxidation reaction, glycerose liquor 50 may be removed from reactor 12 by opening valve 52 and stored or shipped as needed for combination with fodder or a fodder precursor later or at another location. Liquor 50 may instead be reacted directly with fodder or a fodder precursor by feeding liquor 50 through conduit 54 and steam atomizing mixing valve 56 and thence into mixing chamber 60. If desired, the above-described glycerol oxidation reaction scheme may be omitted and a commercially-procured solution containing pure or impure glycerose may instead be fed to mixing chamber 60. Chamber 60 includes a rotating auger 62 powered by motor 64. Protein-containing fodder or fodder precursor such as soybean meal 70 enters chamber 60 via chute 72 and inlet 74. A heating source such as steam regulated by valve 76 enters mixing valve 56 via conduit 78 and thereby heats the fodder or fodder precursor. The heated, auger-mixed combination of fodder or fodder precursor 70 and glycerose liquor 50 exits chamber 60 via outlet 80 and enters heated conditioning chamber 82 where the mixture passes along a series of conveyor belts such as belts 84a, 84b, 84c, 84d, etc. for a period of time sufficient to carry out to a desired extent a non-enzymatic browning reaction between the glycerose and the fodder or fodder precursor. The browned product may be cooled in cooling chamber 86 by passing it along a series of conveyor belts such as belts 86a, 86b, 86c, 86d, etc. Cooling may be assisted using a stream of ambient or chilled air which enters chamber 86 at air inlet 88 and exits at air outlet 90, passing through fan 92, cyclone 94 and filter bag 96. The cooled rumen undegradable protein-containing feed product exits chamber 86 via feed outlet 98 and may be collected in hopper 100 or another suitable vessel or shipping container.

The disclosed partial oxidation products may be in pure or impure form, may represent a mixture of species, and may include dextrorotatory, levorotatory or mixed enantiomers, epimers, dimers or other rearrangement products. The disclosed glycerose liquor appears to include one or more aldehyde-functional species such as D-, L- or D,L-glycerose, and may in addition contain one or more keto-functional species such as dihydroxyacetone, or one or more carboxy-functional species such as glyceric acid or hydroxypyruvic acid. An enediol intermediate formed by rearrangement of glycerose to dihydroxyacetone (or vice-versa) may also be present. The oxidation products may include hydroxyl groups (e.g., 2, 3 or 4 such groups), ether linkages or ring structures. Species which may be present include those shown for example in Scheme 1 at page 21 of Yaylayan et al., “Investigation of DL-glyceraldehyde-dihydroxyacetone interconversion by FTIR spectroscopy”, Carbohydrate Research 318 (1999) 20-25, in Scheme 1 at page 400 of Porta et al., “Selective oxidation of glycerol to sodium glycerate with gold-on-carbon catalyst: an insight into reaction selectivity”, Journal of Catalysts 234 (2004 397-403), and in Scheme 2 at page 4436 of Pagliaro et al. “From Glycerol to Value-Added Products”, Angew. Chem. Int. Ed., 2007, 46, 4434-4440 and at page 166 of Garcia et al., “Chemoselective catalytic oxidation of glycerol with air on platinum metals”, Applied Catalysis A: General 127 (1995) 165-176.

The partial oxidation products desirably are obtained by oxidizing pure or impure glycerol. A variety of oxidation methods may be employed, including reacting glycerol with an oxidizing agent in the presence of a suitable catalyst; reacting glycerol with oxygen or air using water as a solvent; or reacting glycerol via enzyme oxidation, bacterial fermentation, catalytic oxidation or combinations thereof. Representative oxidation methods may be adapted, for example, from Witzemann, JACS 36, p. 2223-33 (1914) where glycerol is reacted with hydrogen peroxide in the presence of ferrous sulphate to make dl-glyceric aldehyde; from Garcia et al., supra, and Porta et al., supra; from U.S. Pat. No. 4,353,987 where glyceraldehyde is produced from a methanol dehydrogenase enzyme; and from U.S. Pat. No. 5,998,608 where sodium arbinoate is converted to D-glyceraldehyde using cobalt chloride hexahydrate and hydrogen peroxide. The disclosed partial oxidation reaction desirably is controlled so that glycerose is produced at high yield without further reaction to form more completely oxidized species such as glyceric acid.

When impure glycerol starting solutions are employed, their composition may vary depending upon the glycerol supply source and other factors such as the presence of side products. For example, some biodiesel-derived glycerol starting solutions appear to be more susceptible than others to foaming when oxidized, perhaps due the presence of larger amounts of free fatty acids. An increased likelihood of foaming may also be observed when using highly concentrated glycerol starting solutions. However, the starting solution desirably has a relatively high initial glycerol concentration, e.g., more than more than 10 wt. %, more than 30 wt. %, more than 50 wt. % or more than 60 wt. % glycerol. Highly concentrated glycerol starting solutions can provide partially oxidized glycerose liquors containing glycerose in high concentrations. These glycerose-rich liquors may in turn permit the manufacture of RUP-containing ruminant feeds requiring less heating. Biodiesel-derived crude glycerin (whose glycerol concentration may be as much as 70 to 80 wt. % or more) is an especially preferred starting solution. For some glycerol starting solutions it may be useful to alter or adjust the chosen oxidation process to reduce or compensate for undesired side reactions, exotherm, foaming or other artifacts which may be observed using that particular starting solution.

A preferred method for making the disclosed partial oxidation products involves reacting a concentrated glycerol starting solution with an oxidizing agent such as hydrogen peroxide in the presence of a suitable catalyst (for example, Fenton's reagent) and a suitable chelating agent (for example, EDTA). Other chelating agents such as citric acid could also be used, but may also have an increased tendency to interact with ferrous ion and fatty acids in some crude glycerins, e.g., by causing scum formation. The catalyst, chelating agent or both may be predissolved in water or other suitable solvents or added directly to the glycerol solution. Use of direct addition will reduce the extent of glycerol solution dilution and may help increase the extent or rate of glycerose formation. The oxidation reaction may be performed at any convenient temperature or pressure, e.g., at ambient or elevated temperature and ambient, reduced or elevated pressure. Preferably the oxidation reaction is performed at a temperature less than about 90° C., less than about 70° C. or less than about 50° C. Sufficient oxidant desirably is employed so as to attain the desired degree of reaction, for example about 0.2 to about 2 moles oxidant, about 0.3 to about 1.5 moles oxidant, about 0.5 to about 1.2 moles oxidant or about 0.8 to about 1 moles oxidant per mole of glycerol. Production costs may increase as more oxidant is used, but increasing the oxidant:glycerol ratio may also improve the extent or rate of glycerose formation.

Sufficient catalyst to achieve the desired rate of reaction desirably is also employed. For example, when using an iron-containing catalyst (e.g., a ferrous ion catalyst), the catalyst amount may be e.g., about 500 to about 3000 ppm iron, about 500 to about 2000 ppm iron or about 500 to about 1500 ppm iron based on the total reaction mixture weight. When a chelating agent is employed, the chelant may for example be used in an amount sufficient to complex all of the catalyst, e.g., at up to about twice the catalyst weight. The reaction desirably is conducted under acidic condition, e.g., at a pH less than 7, less than 6, less than 5, less than 4 or less than 3. The rate or extent of the oxidation reaction may be monitored in a variety of ways including monitoring elapsed reaction time or reaction mixture temperature, or by performing spectroscopic or titrimetric measurements on samples withdrawn from the reaction mixture to monitor the appearance of reaction products or reactive groups or the disappearance of reactants or reactive groups. The reaction desirably is halted before the glycerose is converted to other products such as glyceric acid, dihydroxyacetone and the like. The reaction thus should not be taken as far as is the case in some of the above-mentioned glycerol oxidation procedures, e.g., as in Porta et al.

A variety of fodders may be employed to make the disclosed ruminant feed products. Representative fodders include soybeans, lentils, cowpeas, peas, kidney beans, lima beans and other beans; clovers; seeds and seed products including canola, cottonseed, flaxseed, linseed, mustard seed, peanut, safflower, sesame and sunflower; cereals and other crops including alfalfa, barley, maize (corn), millet, oats, sorghum and wheat; by-product protein feedstuffs such as distillers and brewers grains, feather meal, fish products, milk products, poultry products and sugar beet waste; seaweed; and mixtures thereof. The fodder may already be in a ruminant-consumable form or may be a fodder precursor intended for further processing into a fodder product. For example, the fodder or fodder precursor may be in the form of whole or crushed seeds or grains, meal, flour, oil cake, press cake, pellets and syrup. The fodder may be a commercially available feed such as a high protein feed (for example, RALLY™ high energy lipid ration or METAPRO™ lactation rations, both from Lake O'Lakes Purina Feed LLC).

The reaction between glycerose and fodder or fodder precursor may be performed using any convenient mixing technique, mixing ratio, temperature and time sufficient to provide increased resistance to rumen degradation for protein, lipids or both protein and lipids in the fodder or fodder precursor and thereby make them ruminally inert. A feed product containing ruminally inert protein may for example be prepared by combining glycerose and the fodder or fodder precursor by spraying or dripping glycerose onto the fodder or fodder precursor, or by using a mixing auger or other suitable device to combine the ingredients. The mixing ratio may conveniently be expressed in terms of the glycerose add-on rate. When using glycerose liquor, this may be calculated by determining the aldehyde content of the glycerose liquor (depending on the technique, doing so may also measure the amount of ketones such as dihydroxyacetone) and comparing the aldehyde amount expressed as the weight of an equivalent amount of pure glycerose to the fodder or fodder precursor dry matter weight. The reaction between glycerose and the fodder or fodder precursor is believed generally to be a 1 mole to 1 mole reaction between free carbonyl groups in the glycerose or glycerose liquor and free amino groups in the fodder or fodder precursor. For example, the pure glycerose equivalent amount may be at least about 0.25 wt. %, at least about 0.5 wt. %, at least about 0.75 wt. %, at least about 1 wt. %, at least about 1.5 wt. % or at least about 2 wt. % of the fodder or fodder precursor dry weight. The pure glycerose equivalent amount may for example also be less than about 6 wt. %, less than about 5 wt. %, less than about 4 wt. %, less than about 3 wt. %, less than about 2.5 wt. % or less than about 2 wt. % of the fodder or fodder precursor dry weight.

Glycerose (e.g., glycerose liquor) may also be combined with a cracked or crushed oilseed body to provide a feed product containing ruminally inert lipid(s). The resulting product may include a substantial amount of small particles having a lipid interior and a coating formed of reaction products of glycerose with proteinaceous membranes from oilseeds. The coating may encapsulate the lipid in a protective matrix, thereby forming a compartment of protected protein containing the lipid such that the entire compartment and its lipid content escape degradation by rumen bacteria yet are digestible in the small intestine or abomassum of a ruminant. Some of the ruminally inert lipid may be transferred in polyunsaturated form to the ruminant milk, and the formation of trans-fatty acids in the rumen by bacterial hydrogenation may be reduced. The feed product may for example be prepared by first selecting the desired oilseed or mixture of seeds and breaking the seed cuticle by mechanical cracking, e.g. using a roller mill. Any other suitable method for breaking or cracking the seed cuticle may be employed, while taking care not to release oil unduly during the crushing process. The oilseeds may optionally be dried before or after cracking. Typically, this is accomplished by heating with hot air. Dry seeds may more readily absorb glycerose into the seed interior. However, drying may also increase production costs. The cracked seeds may be treated with glycerose by applying glycerose or glycerose liquor in any suitable manner, for example by spraying, dripping, mixing, steeping or any other convenient method. The glycerose desirably is allowed or caused to penetrate the seed interior, and optionally assisted via the use of steam, hot air, microwave energy, externally applied heat or any other convenient heating source. Desirably, sufficient glycerose is distributed within the oilseed so that at least thirty percent of the lipid content is rendered ruminally inert. The resulting product may include ruminally inert lipid bodies of about 0.5 to about 10 micrometers average diameter, with the actual range of diameters typically depending on the chosen oilseed. For example, the lipid bodies in soybeans may have a size range between about 0.5 and about 2 micrometers. The ruminally inert bodies may for example include the lipid in its in situ natural form surrounded by a shell layer of the reaction product of a protein and glycerose, with the ratio of reaction product to lipid being for example between about 1 and 35 wt. %. The ratio of the reaction product to oleosin proteins in the shell layer may for example be about 0.5 to about 40 wt. %. The reaction product may for example be more dense than the lipid layer and relatively thin, e.g., with a thickness less than 10% of the lipid body diameter. The product may be ground if desired. The lipid bodies in such a ground product desirably are sufficiently small so as to remain intact and ruminally inert.

Whether the feed product involves ruminally inert protein, ruminally inert lipids or both, the reaction between glycerose and the fodder or fodder precursor may be referred to as a browning reaction. Under some mixing and handling conditions browning might not be required or observed. The reaction may be performed at any convenient temperature, e.g., ambient or elevated temperature, so long as the fodder or fodder precursor does not undergo excessive thermal degradation. The reaction temperature may for example be at least about 20° C., at least about 25° C. or at least about 30° C. as determined by measuring the mixture temperature. The reaction temperature may also for example be less than about 130° C., less than about 120° C. or less than about 100° C. The reaction may also be performed at any convenient pressure, e.g., ambient, elevated or reduced pressure. Steam, externally applied heat, or both steam and externally applied heat may be used. Steam may also be employed to regulate the moisture content of the fodder or fodder precursor, or of the completed feed product, and as an aid to penetration into an oilseed interior. The feed product moisture content after heating may for example be about 6% to about 40% by weight. In another useful embodiment, glycerose and the fodder or fodder precursor are combined in an extruder or pelletizer and the frictional heat of mixing is relied upon to carry out the reaction. Where externally-applied heat is employed, glycerose and the fodder or fodder precursor may for example be heated for at least about 5 minutes, at least about 10 minutes, at least about 15 minutes, at least about 30 minutes, at least about 45 minutes or at least about 1 hour. The total heating time may also for example be less than about two hours, less than about one hour, less than about 45 minutes, less than about 30 minutes, less than about 15 minutes or less than about 10 minutes. Heating may be discontinued and the mixture allowed to cool for a period of time (e.g., 30 minutes or more, one hour or more, or two hours or more) while further reaction (conditioning) takes place.

The amount of ruminally inert protein or lipid in a feed product can be tailored to a variety of situations, including the chosen feed, ruminant, feeding schedule and desired milk characteristics. For example, the chosen glycerose add-on amount, heating times and temperatures may be evaluated in a variety of ways, including the use of in vitro or in situ feed studies such as those described in the above-mentioned U.S. Pat. Nos. 4,957,748, 5,023,091, 5,064,665 and 5,789,001 and in Published U.S. Patent Application No. US 2008/0152755 A1. The evaluation may examine RUP, rumen-undigested oil or fat (RUF), or combinations of RUP and RUF. The procedure shown below was employed at the FARME Institute (Homer, N.Y.) to evaluate RUP levels:

### FARME Institute In Situ Testing Protocol

Feed samples are tested for digestibility in situ using high producing lactating dairy cows in an early to mid stage of lactation. The cows are fed a standard dairy cattle ration balanced according to 2001 NRC recommendations. Sample sets are run in triplicate using approximately 5 g dry matter (DM) in each subset. Coarse feed samples such as whole cottonseed and soybeans are coarsely chopped prior to weighing. The as-received or if need be chopped samples are weighed into a 10 cm×20 cm nitrogen-free porous polyester bags whose pore size is 50±15 micrometers. The bags are heat-sealed after filling. The bags are soaked in water to moisten the feed, and then incubated in the rumen of a single cannulated cow. After incubation for a specified time period (e.g., 16 hours), the samples are withdrawn, frozen for a minimum of 12 hours, thawed and machine rinsed with cold water. The rinsed samples are then fully dried in a convection drying oven for a minimum of 12 hours at 49° C. and weighed. Standard disappearance calculations are employed and coefficients of variation are determined for each sample. Outliers are not used in the final average if the coefficients of variation are greater than 10%. Chemical analysis of fat and protein is conducted on both the original feed samples and the digestive residues at the Dairy One Cooperative forage laboratory (Ithaca, N.Y.). Disappearance of protein is calculated by determining the grams of protein remaining after digestion and subtracting that quantity from the grams of protein placed into the in situ bag. The percentage of protein that has disappeared is described as rumen degradable protein (RDP). The percentage that remains is rumen undegradable protein (RUP). Disappearance of other nutrients is determined in a like manner.

The disclosed ruminant feed product desirably exhibits at least about a 25% reduction and more preferably at least about a 50% reduction in RDP compared to a control feed that has not been reacted with an oxidation product of glycerol. Expressed another way, the ruminant feed product desirably contains at least about 50%, at least about 60% or at least about 70% RUP as a percent of crude protein (CP). The feed product may be stored, packaged or further modified as desired (e.g., by pelletizing, or by adding at least one nutrient, medication, vitamin, etc.) prior to being administered to ruminant animals. Appropriate storage and packaging techniques and feed product modifications will be familiar to persons having ordinary skill in the art.

Ruminants to which the disclosed feed product may be administered include cattle (both dairy and beef cattle), goats, sheep, alpacas, antelope, bison, camels, deer, giraffes, llamas, water buffalo, wildebeest and yaks. The feed product typically will be administered as a feed supplement, e.g., at about 0.5 to about 20, about 1 to about 10 or about 1 to about 5% of the total feed intake. Administration amounts may be determined empirically and may be based on factors including weight gain, milk production, milk content or meat analysis.

The invention is further described in the following Examples, in which all parts and percentages are by weight unless otherwise indicated.

### EXAMPLE 1

### Glycerose Liquor Preparation

A 1.5 part quantity of ferrous sulfate heptahydrate catalyst was placed in an open reaction vessel equipped with a mechanical stirrer and chilled using an ice water bath. The catalyst was dissolved in 15 parts deionized water and 200 parts of a biodiesel-derived glycerol waste stream containing 85% glycerol obtained from Cargill Inc. (Minnetonka, Minn.). A second reaction mixture was similarly prepared using a reaction vessel whose temperature was controlled using an ambient temperature water bath instead of ice water. The two reaction vessels were designated as Cool (C) and Warm (W). A 50 part quantity of 35% hydrogen peroxide was added dropwise to each reaction vessel over a one hour period. The reaction vessels were allowed to stand for a 30 minute rest period during which the pH was measured and adjusted to 3.0 using 5N sodium hydroxide as needed and 20 parts of the reaction mixture were collected.

A portion of the collected reaction mixture was analyzed to determine the reducing sugar content and reported as a weight percent equivalent of reducing moieties in the sample compared to a known glucose standard. The standard was prepared by dissolving 0.1439 g dry glucose in 500 mL deionized water. A 5 mL aliquot (viz., a portion containing 1.439 mg glucose) was combined with 5 mL of Copper Reagent (prepared by dissolving 53 g Na₂HPO₄.7H₂O and 40 g NaKC₄H₄O₆.4H₂O in about 70 ml of water, followed by 100 mL portions of 1N sodium hydroxide, 8 g CuSO₄.5H₂O, 180 g Na₂SO₄, and 0.7134 g KIO₃, and after everything had dissolved diluting the solution to 1 L) and heated to 100° C. for 40 minutes. The mixture was cooled, combined with potassium iodide and a starch indicator, and titrated with sodium thiosulfate. A net addition of 14.6 mL titrant was required compared to a blank prepared without glucose. The standard accordingly had a “Sugar Factor” of 0.0989 mg glucose/mL titrant. A portion of the collected reaction mixture sample (e.g., 1.01 g) was diluted to 500 mL and a 5 mL aliquot was combined with Copper Reagent, heated and titrated with thiosulfate in a similar manner. The net titrant required was multiplied by the Sugar Factor to determine the sample portion reducing sugar content.

The hydrogen peroxide addition, rest, sampling and analysis procedures were repeated four more times (for a total of five hydrogen peroxide additions in all) by adding a hydrogen peroxide amount corresponding to 25% of the amount of glycerol-containing biodiesel waste stream remaining in the reaction vessel. The material balance and reducing sugar results for the Cool and Warm reaction vessels are shown below in Tables 1A and 1B.

TABLE 1A
Cool Reaction Vessel Material Balance and Reducing Sugar Content

| | Amount in Reaction Vessel, Parts | | | | | | | |
|---|---|---|---|---|---|---|---|---|
| | | | Biodiesel | | | | | Percent |
| | | | Waste | | | | | Reducing |
| | | | Stream | | | | | Sugars |
| | | | (85% | | | | Collected | (Glucose |
| Time | FeSO₄•7H₂O | Water | Glycerol) | H₂O₂ | NaOH | Total | Sample | Equiv.) |
| 7:00 | +1.5 | +15 | +200 | +50 | | 267 | | |
| 8:15 | 1.5 | 15 | 200 | 50 | +4.21 | 271 | | |
| 8:30 | 1.4 | 13.9 | 185.2 | 46.3 | 3.9 | 251 | −20 | 10.60 |
| 8:30 | | | | +46.3 | | | | |
| 9:30 | 1.4 | 13.9 | 185.2 | 92.6 | 3.9 | 297.0 | | |
| 9:45 | | | | | 0 | | | |
| 9:55 | 1.3 | 13.0 | 172.8 | 86.4 | 3.6 | 277.0 | −20 | 15.80 |
| 10:00 | | | | +43.3 | | | | |
| 10:00 | 1.3 | 13.0 | 172.8 | 129.7 | 3.6 | 320.3 | | |
| 11:15 | | | | | +2.63 | | | |
| 11:20 | 1.2 | 12.1 | 162.0 | 121.6 | 5.9 | 300.3 | −20 | 18.00 |
| 11:30 | | | | +40.7 | | | | |
| 11:30 | 1.2 | 12.1 | 162.0 | 162.3 | 5.9 | 343.5 | | |
| 12:45 | | | | | +5.36 | | | |
| 12:50 | 1.1 | 11.4 | 152.5 | 152.8 | 10.6 | 323.5 | −20 | 17.40 |
| 13:00 | | | | +38.2 | | | | |
| 13:00 | 1.1 | 11.4 | 152.5 | 191.0 | 10.6 | 366.7 | | |
| 14:15 | | | | | +8.58 | | | |
| 14:20 | 1.1 | 10.8 | 144.2 | 180.6 | 18.1 | 346.7 | −20 | 15.60 |

TABLE 1B
Warm Reaction Vessel Material Balance and Reducing Sugar Content

| | Amount in Reaction Vessel, Parts | | | | | | | |
|---|---|---|---|---|---|---|---|---|
| | | | Biodiesel | | | | | Percent |
| | | | Waste | | | | | Reducing |
| | | | Stream | | | | | Sugars |
| | | | (85% | | | | Collected | (Glucose |
| Time | FeSO₄•7H₂O | Water | Glycerol) | H₂O₂ | NaOH | Total | Sample | Equiv.) |
| 7:00 | +1.5 | +15 | +200 | +50 | | 267 | | |
| 8:15 | 1.5 | 15 | 200 | 50 | +1.34 | 268 | | |
| 8:30 | 1.4 | 13.9 | 185.2 | 46.3 | 1.2 | 248 | −20 | 11.40 |
| 8:30 | | | | +46.3 | | | | |
| 9:30 | 1.4 | 13.9 | 185.2 | 92.6 | 1.2 | 294.4 | | |
| 9:45 | | | | | +3.68 | | | |
| 9:55 | 1.3 | 13.0 | 172.8 | 86.4 | 4.6 | 274.4 | −20 | 16.20 |
| 10:00 | | | | +43.3 | | | | |
| 10:00 | 1.3 | 13.0 | 172.8 | 129.7 | 4.6 | 321.1 | | |
| 11:15 | | | | | +3.31 | | | |
| 11:20 | 1.2 | 12.1 | 162.0 | 121.6 | 7.4 | 301.1 | −20 | 18.40 |
| 11:30 | | | | +40.7 | | | | |
| 11:30 | 1.2 | 12.1 | 162.0 | 162.3 | 7.4 | 344.9 | | |
| 12:45 | | | | | +5 | | | |
| 12:50 | 1.1 | 11.4 | 152.5 | 152.8 | 11.7 | 324.9 | −20 | 17.50 |
| 13:00 | | | | +38.2 | | | | |
| 13:00 | 1.1 | 11.4 | 152.5 | 191.0 | 11.7 | 367.8 | | |
| 14:15 | | | | | +9.6 | | | |
| 14:20 | 1.1 | 10.8 | 144.2 | 180.6 | 20.1 | 347.8 | −20 | 16.20 |

The individual samples from the Cool reaction vessel were identified as 1C, 2C, 3C and so on depending on whether the sample was collected at the first, second, third, etc. sample collection period shown in Table 1A. In similar fashion, the individual samples from the Warm reaction vessel were identified as 1W, 2W, 3W and so on depending on whether the sample was collected at the first, second, third, etc. sample collection period shown in Table 1B.

During the reaction, the Cool reaction vessel temperature was about 20-30° C. and the Warm reaction vessel temperature was about 45-55° C. A strong exotherm occurred when making the initial hydrogen peroxide addition, with less strong exotherms being observed for subsequent peroxide additions. The results in Tables 1A and 1B show that the reaction was not greatly affected by temperature, but that the Warm reaction provided somewhat greater reducing sugar content than the Cool reaction after corresponding reaction times.

The results in Tables 1A and 1B also show that the reducing sugar content peaked at around the third sample (3C or 3W) collection period. The ferrous ion catalyst may by that point have become sufficiently diluted so that further reaction would not take place without additional catalyst. The extent or rate of reaction may be improved by maintaining the concentration of ferrous ion at about 1000 ppm or more.

Analysis of sample 3W showed that a 5 mL aliquot of a diluted 1.01 g sample portion contained the equivalent of 1.87 mg glucose. Factoring in dilution, the original 1.01 g sample portion must have contained 187 mg of glucose equivalent, or 1.04 mmoles. At the time sample 3W was collected, the Warm reaction mixture contained 321 g of reactants, corresponding to 333 mmoles of glucose equivalent. This may be presumed to be 0.33 moles glycerose, plus unreacted glycerol, side reaction products such as dihydroxyacetone, and potentially other species as well. Based on the material balance shown in Table 1B, this 321 g reactant mixture was derived from 173 g of the biodiesel waste stream and 130 g of hydrogen peroxide, corresponding to about 1.6 moles glycerol and 1.3 moles hydrogen peroxide. This indicates that about 21% of the starting glycerol amount formed the target aldehyde, and that the extent of reaction might be further improved.

### EXAMPLE 2

### Feed Preparation

Portions of the collected samples from Example 1 were mixed with soybean meal (SBM) and heated to prepare an RUP-containing ruminant feed product. For each treatment a 150 g SBM portion which had been screened through a U.S. No. 8 sieve was combined with sufficient collected sample to add 1% glycerol or glycerol-derived oxidation products to the finished blend. The collected sample add-on amount was calculated on a dry matter basis with an assumption that the collected sample liquor contained unreacted glycerol, glycerose, dihydroxyacetone and possibly other byproducts. The SBM and collected sample portion were mixed in a plastic bowl in the amounts shown below in Table 2 and blended with an electric hand mixer. The resulting mixtures contained 80% dry matter (DM). Each mixture was placed in a glass jar, heated in a microwave oven for one minute, and then heated in a 105° C. oven for 15 or 30 minutes. The contents of the jars were spread onto paper, and allowed to cool and dry. The dried samples were sent to the FARME Institute for a 16 hour in situ protein degradation evaluation. The results are shown below in Table 2:

TABLE 2
Feed Treatments and Protein Evaluations

| | | Dosage, | Heating | | | |
|---|---|---|---|---|---|---|
| Run | Collected | % | Time, | Crude Protein | RUP, % | RUP, % |
| No. | Sample | DM | min | (CP), % of DM | of DM | of CP |
| 2-1 | 0 | 0 | 30 | 50.8 | 28.9 | 43.4 |
| 2-2 | 1W | 0.5 | 30 | 50.7 | 36.1 | 55.1 |
| 2-3 | 1W | 1 | 30 | 51.6 | 34.6 | 54.6 |
| 2-4 | 1C | 1 | 30 | 51.1 | 33.4 | 51.8 |
| 2-5 | 2W | 0.5 | 30 | 52.1 | 34.0 | 53.0 |
| 2-6 | 2W | 1 | 30 | 51.0 | 41.7 | 67.4 |
| 2-7 | 2C | 1 | 30 | 51.6 | 42.5 | 62.2 |
| 2-8 | 3W | 0.5 | 30 | 50.9 | 43.3 | 67.3 |
| 2-9 | 3W | 1 | 30 | 51.6 | 47.7 | 73.9 |
| 2-10 | 3C | 1 | 30 | 51.0 | 49.1 | 75.7 |
| 2-11 | 2W | 1 | 15 | 51.3 | 44.7 | 67.2 |
| 2-12 | 3W | 1 | 15 | 51.2 | 45.8 | 71.0 |

The results in Table 2 show that significant RUP increases were obtained by combining relatively low amounts of glycerose liquor with SBM at a very low heating temperature and for very short heating times. For example, addition of only 0.5% of collected sample 3W raised the RUP amount from 43.4% of Crude Protein (CP) for the control feed (heated but no glycerose liquor addition) to 67.3% of CP. Addition of 1% of collected sample 3W raised the RUP amount to 73.9% of CP using a 30 minute heating time, and to 71% of CP using only a 15 minute heating time. Comparison of Sample No. 2-6 with Sample No. 2-11, and of Sample No. 2-9 with Sample No. 2-12, suggests that the liquor has essentially completely reacted after 15 minutes and that little or no improvement may take place with an additional 15 minutes of heating.

### EXAMPLE 3

### High Temperature Glycerol Oxidation and Feed Preparation

One part ferrous sulfate heptahydrate catalyst was placed in a reaction vessel equipped with a thermometer and mechanical stirrer and dissolved in 10 parts deionized water. 100 Parts of a biodiesel-derived glycerol waste stream containing 80% glycerol obtained from Freedom Fuels, LLC (Mason City, Iowa) were added to the vessel, followed by the dropwise addition of 50 parts of 35% hydrogen peroxide at a rate sufficient to bring the reaction mixture to 90° C. Following completion of the reaction, the resulting glycerose liquor (Liquor A) was analyzed for reducing sugar content using the method of Example 1 and found to contain 16.8% glucose equivalents.

Using the method of Example 2, SBM was combined with sufficient Liquor A to add 2% glycerol or glycerol-derived oxidation products to the finished blend, and heated for 1, 5, 10 or 15 minutes. In comparison runs, SBM was combined with known solutions of glycerose dimer (Dimer A) or dihydroxyacetone dimer (Dimer B), using sufficient solution to add 0.5 wt. % dimer to the finished blend. These blends were heated using the method of Example 2 for 15 minutes. In a further comparison run, SBM was combined with 5 wt. % spent sulfite liquor (XYLIG™ lignosulfonate, LignoTech, USA, Rothschild, Wis.) and heated for 15 or 30 minutes. The resulting dried samples were sent to the FARME Institute for a 16 hour in situ protein degradation evaluation. The results are shown below in Table 3:

TABLE 3
Feed Treatments and Protein Evaluations

| Run | | Dosage, % | Heating | Crude Protein (CP), | RUP, % |
|---|---|---|---|---|---|
| No. | Treatment | DM | Time, min | % of DM | of CP |
| 3-1 | Liquor A | 2 | 1 | 48.6 | 67.9 |
| 3-2 | Liquor A | 2 | 5 | 50.6 | 66.7 |
| 3-3 | Liquor A | 2 | 10 | 49.3 | 71.9 |
| 3-4 | Liquor A | 2 | 15 | 49.7 | 75.4 |
| 3-5 | Dimer A | 0.5 | 15 | 50.4. | 47.5 |
| 3-6 | Dimer B | 0.5 | 15 | 50.2 | 41.0 |
| 3-7 | XYLIG | 5 | 15 | 50.5 | 61.9 |
| 3-8 | XYLIG | 5 | 30 | 47.1 | 72.3 |

The results in Table 3 show that addition of 2% Liquor A provided feed products whose RUP values were comparable to or better than the RUP values obtained using 5% spent sulfite liquor, and made using much shorter heating times. Treatment with glycerose dimer or with dihydroxyacetone dimer provided feeds having generally lower RUP values, suggesting that the test conditions did not permit the dimers to hydrolyze to their corresponding monomeric forms.

### EXAMPLE 4

### Catalyst and Chelant Evaluation

Varying amounts of ferrous sulfate heptahydrate catalyst and EDTA chelant were placed in a reaction vessel equipped with a thermometer, mechanical stirrer and cooling bath, and dissolved in 10 g deionized water. 100 grams of a biodiesel-derived glycerol waste stream containing 83% glycerol obtained from Minnesota Soybean Processors (Brewster, Minn.) were added to the vessel, followed by the addition at five minute intervals of five 1 mL aliquots of 35% hydrogen peroxide. The typical response to the initial 1 mL addition of hydrogen peroxide was an immediate color change from light yellow to reddish brown. At the same time an exothermic reaction occurred that increased the temperature by 6 to 9° C. This exothermic reaction was very rapid as the temperature began to decline after the first minute. During the second or third minute it was common to see small bubbles, presumed to be oxygen, forming in the glycerose liquor. The exothermic reaction appeared to take place before the appearance of bubbles. When the level of iron was 0.5 g or more the exotherm continued with each incremental addition of hydrogen peroxide. When iron was omitted, no heating occurred with addition of peroxide.

After 25 minutes, additional hydrogen peroxide was added to each reaction mixture in a continuous dropwise stream at approximately 1 mL/min while cooling the reaction vessel sufficiently to maintain the reaction mixture at 50 to 60° C., until a total of 44.4 mL (50 g) of hydrogen peroxide had been added. Effervescence was common to most treatments, with audible fizzing occurring as the bubbles broke the surface. This is most likely oxygen and represents a waste of hydrogen peroxide, the single most expensive ingredient. The peroxide might be used more efficiently if the addition rate were slower or if the reaction were carried out at elevated pressure. In a commercial setting, a slower addition rate might provide additional time for the removal of heat.

Acidity was measured using a pH meter. Following completion of the reaction, the resulting glycerose liquors (Liquors B through H) were analyzed for reducing sugar content using the method of Example 1 but with comparison to a glycerose standard rather than a glucose standard. The liquors were also analyzed for carboxyl content using conductometric titration.

Using the method of Example 2, a 30 minute heating time and an add-on rate sufficient to provide 1% glycerol-derived product in the finished blends, glycerose liquors B through G were used to treat SBM and determine their potential to generate RUP. A SBM sample was also treated with sufficient water to increase the moisture content to 20% and heated for ten minutes. The resulting samples were exposed to air to allow cooling and drying, and sent to the FARME Institute for a 16 hour in situ protein degradation evaluation. The results are shown below in Table 4:

TABLE 4
Feed Treatments and Protein Evaluations

| | | | | | | Glycerose | | RUP, |
|---|---|---|---|---|---|---|---|---|
| Run | | Fe++ | | | | Equivalent, | Carboxyl, | % of |
| No. | Treatment | Catalyst, g | EDTA, g | pH | Exotherm | wt. % | % | CP |
| 4-1 | Liquor B | 0.5 | — | 2.15 | Strong | 17.4 | 3.2 | 74.6 |
| 4-2 | Liquor C | 1.0 | — | 2.09 | Strong | 17.1 | 2.5 | 76.0 |
| 4-3 | Liquor D | 2.0 | — | 1.93 | Strong | 14.8 | 3.5 | 69.8 |
| 4-4 | Liquor E | 0.5 | 1.0 | 2.45 | Strong | 18.6 | 1.7 | 70.4 |
| 4-5 | Liquor F | 1.0 | 1.0 | 2.53 | Strong | 17.7 | 1.8 | 66.7 |
| 4-6 | Liquor G | 0.25-0.35 | — | 1.77 | Mild | 0.9 | 9.4 | 51.1 |
| 4-7 | Water | 1.0 | — | — | None | — | — | 42.8 |

Increasing the level of ferrous sulphate (Fe++ catalyst) tended to reduce the observed aldehyde level (reported in Table 4 as the Glycerose Equivalent) and lower the pH, suggesting that some of the aldehyde may have been further oxidized to a carboxylic acid. Addition of EDTA tended to increase the observed aldehyde level, raise the pH, and reduce the carboxyl level, all favourable responses. EDTA additions thus seemed to reverse the effect of high catalyst levels, suggesting that the EDTA was chelating the ferrous ion. A combination of 0.5 g ferrous sulfate and 1.0 g of EDTA appeared to provide a desirable level of RUP and suggested that the chelated iron remained effective as a catalyst. A reduced RUP value was observed for SBM treated with Liquor F (made using 1 g each of catalyst and EDTA). Increased glycerose equivalent and RUP levels were observed for SBM treated with Liquor E (made using 0.5 g catalyst and 1 g EDTA), suggesting additional improvements might be obtained by adjusting the catalyst and EDTA amounts or the ratio of EDTA to catalyst. For example, 100 g crude glycerol and 10 g water might be combined with about 0.5 g catalyst and 0.7 g EDTA to provide a starting mixture containing about 900 ppm iron and about 0.6 wt. % EDTA.

Biodiesel-derived glycerol often contains a small amount of fatty acid, and the Minnesota Soybean Processors glycerol used in this Example is said to include 0.15% fatty acids. Fatty acids may be capable of combining with divalent cations to form insoluble salts analogous to those responsible for bath tub ring formation. In some of the runs noted above a reddish brown scum was observed to have adhered to the sides of the reaction vessel, possibly due to a combination of fatty acid(s) (e.g., linoleic acid) with the ferrous ion catalyst. If carried out on a commercial scale a similar combination might lead to formation of greasy globs capable of blocking filters or nozzles. The addition of EDTA appeared to reduce or eliminate scum formation and was thought to be due to chelation of the ferrous ion and consequent reduction or prevention of its interaction with fatty acids.

For Liquor G, the low initial catalyst level appeared to provide a milder exotherm, and the temperature began to decline 30 minutes after start of the initial peroxide addition even as the peroxide addition continued. This suggested that the additional peroxide was not reacting due to iron depletion or deficiency in the reaction mixture. At t=35 minutes, a further 0.1 g of ferrous sulfate was added to the reaction mixture. Over the next 5 minutes no further peroxide was added but the temperature increased, indicating that unreacted peroxide had been present in the liquor. The peroxide addition was resumed at t=40 minutes but the temperature began to decline again after t=50 minutes. The concentrations of ferrous ion when the temperature began to decline were 430 and 520 ppm, suggesting that for this reaction vessel and under these conditions, a possible minimum catalyst level might be about 500 to about 600 ppm. Analysis of Liquor G showed it to have a high carboxyl content and very little aldehyde, suggesting that a low ferrous ion concentration may favor further oxidation of aldehydes and formation of carboxylic acids.

### EXAMPLE 5

The method of Example 4 was repeated using the Freedom Fuels, LLC glycerol waste stream employed in Example 3. The resulting dried samples were sent to the FARME Institute for a 16 hour in situ protein degradation evaluation. The results are shown below in Table 5:

TABLE 5
Feed Treatments and Protein Evaluations

| | | | | | Glycerose | | |
|---|---|---|---|---|---|---|---|
| Run | | Fe++ | | | Equivalent, | Carboxyl, | RUP, % of |
| No. | Treatment | Catalyst, g | EDTA, g | pH | wt. % | % | CP |
| 5-1 | Liquor H | 0.5 | — | 2.32 | 18.3 | 2.5 | 78.4 |
| 5-2 | Liquor I | 1.0 | — | 2.00 | 16.9 | 2.3 | 77.9 |
| 5-3 | Liquor J | 2.0 | — | 1.88 | 16.7 | 2.5 | 76.1 |
| 5-4 | Liquor K | 0.5 | 1.0 | 2.70 | 19.2 | 1.7 | 71.5 |
| 5-5 | Liquor L | 1.0 | 1.0 | 2.47 | 16.9 | 2.2 | 57.9 |

Like the results in Table 4, the results in Table 5 demonstrated high RUP levels.

### EXAMPLE 6

### Fodder Heating Time Effects

Liquor E from Table 4 and Liquor K from Table 5 were combined with SBM using the method of Example 2 and heated for 1, 10 or 30 minutes. During the one minute heating time, the liquor-SBM mixture temperatures were observed to increase from 25 to about 95° C. A SBM sample was also treated with water to bring the total moisture level to 20% and heated for one minute. The resulting dried samples were sent to the FARME Institute for a 16 hour in situ protein degradation evaluation. The results are shown below in Table 6:

TABLE 6
Effect of Fodder Heating Times

| Run | | | RUP, % of |
|---|---|---|---|
| No. | Treatment | Heating Time, min | CP |
| 6-1 | Liquor E | 1 | 61.4 |
| 6-2 | Liquor E | 10 | 71.5 |
| 6-3 | Liquor E | 30 | 70.4 |
| 6-4 | Liquor K | 1 | 50.9 |
| 6-5 | Liquor K | 10 | — |
| 6-6 | Liquor K | 30 | 71.5 |
| 6-7 | Water | 1 | 42.8 |

As shown in Table 6, both liquors provided feed products with increased RUP versus a water only control, even after as little as one minute of heating. This demonstrates that that the disclosed glycerose liquors can provide RUP improvements with low heating times and temperatures.

### EXAMPLE 8

### Reducing Sugar Comparison

Using the method of Example 3 and a heated water bath, xylose (X107-5 from Sigma-Aldrich Co.), glycerose (G5001 from Sigma-Aldrich Co.), dihydroxyacetone dimer (DHA Dimer, D107204 from Sigma-Aldrich Co.), or glycerose liquor (containing 19.2% glycerose equivalents by weight) were combined at two different overall dosage levels with sufficient water to provide final feed products with a 20% moisture content. The resulting solutions were cooled, combined in a plastic bowl with SBM which had been screened through a US No. 8 sieve and which contained 96.5% dry matter, mixed using a hand mixer, transferred to a 0.46 L jar and heated in a microwave oven for one minute. The mixtures were then heated in a 105° C. oven for 10 or 30 minutes, reaching varying degrees of browning. The samples were cooled and sent to the FARME Institute for a 16 hour in situ protein degradation evaluation. The results are shown below in Table 7:

TABLE 7
Reducing Sugar Comparisons

| | | Rumen Undegraded Protein | | |
|---|---|---|---|---|
| Run | | Dosage, % | | RUP, % of |
| No. | Treatment | DM | Heating Time, min | CP |
| 8-1 | Xylose | 0.5 | 10 | 49.2 |
| 8-2 | Xylose | 1 | 10 | 55.9 |
| 8.3 | Xylose | 0.5 | 30 | 59.2 |
| 8.4 | Xylose | 1 | 30 | 64.4 |
| 8-5 | Glycerose | 0.5 | 10 | 56.0 |
| 8-6 | Glycerose | 1 | 10 | 65.9 |
| 8-7 | Glycerose | 0.5 | 30 | 59.8 |
| 8-8 | Glycerose | 1 | 30 | 71.8 |
| 8-9 | DHA Dimer | 0.5 | 10 | 58.8 |
| 8-10 | DHA Dimer | 1 | 10 | 67.3 |
| 8-11 | DHA Dimer | 0.5 | 30 | 63.5 |
| 8-12 | DHA Dimer | 1 | 30 | 76.9 |
| 8-13 | Glycerose Liquor | 0.75 | 10 | 52.8 |
| 8-14 | Glycerose Liquor | 1.5 | 10 | 71.9 |
| 8-15 | Glycerose Liquor | 0.75 | 30 | 52.4 |
| 8-16 | Glycerose Liquor | 1.5 | 30 | 66.9 |

When a 1.5% dosage of glycerose liquor was employed, approximately 0.57% glycerose equivalents were present. Thus it may be appropriate to compare RUP results for the 1.5% glycerose dosage to those obtained using 0.5% xylose, glycerose or DHA dimer. When this comparison is made, the glycerose equivalents in the glycerose liquor appear to be more effective than the pure sugars for providing RUP protection. Generation of RUP appeared to be largely complete after heating for 10 minutes.

### EXAMPLE 9

### Pelletizing

Four 1 kg portions of SBM (Schofield Feeds, Schofield Wis.) were each combined with 20 g glycerose liquor (containing 18.8% glycerose equivalents by weight) and blended in a KITCHENAID™ mixer (KitchenAid, USA). The batches were combined into a single 4 kg batch, then pelletized at 85° C. using a CL-Type 2 laboratory pellet mill (California Pellet Mill Co.) fitted with a 4 mm ( 5/32 in.) die and a steam conditioning chamber. The mill was pre-warmed to 88° C. using a mixed feed. Steam was applied directly to the feed in the conditioning chamber at 0.28 MPa to provide both heat and moisture. Retention time in the conditioner and pellet mill was about 30 seconds. The first minute of production was used to flush the pelletizing system and was discarded. The remainder was collected in a container and allowed to cool under ambient conditions in a bed about 76 mm deep. The cooled pellets were crumbled and sent, along with samples of unpelletized and pelletized plain SBM, to the FARME Institute for a 16 hour in situ protein degradation evaluation. The results are shown below in Table 8.

TABLE 8
Unpelletized and Pelletized Soybean Meal

| Run | | CP, % of | RUP, % of |
|---|---|---|---|
| No. | Treatment | DM | CP |
| 9-1 | SBM | 50.5 | 25.4 |
| 9-2 | Pelletized SBM | 49.1 | 20.8 |
| 9-3 | SBM treated with glycerose | 46.6 | 44.4 |
| | liquor and pelletized | | |

The data in Table 8 shows that pelletizing SBM which had been reacted with glycerose liquor more than doubled the RUP compared to pelletizing unreacted SBM. Further increases might be observed by using longer conditioning times or higher glycerose levels.

When this example was repeated using canola meal, browning was observed but the RUP results were lower than expected. The crumbled canola feed particles were much smaller than those obtained using SBM, and are believed to have escaped through the Dacron bag mesh during the in situ test, thereby distorting the measured results.

### EXAMPLE 10

### Ambient Temperature Fodder Treatment

150 Parts SBM containing 96.5% DM were combined with sufficient glycerose liquor containing 23% glycerose equivalents and water to provide 0.0 or 2.0 wt. % glycerose liquor based on the dry matter weight and a 20% total moisture level. This was accomplished by blending the SBM with either 31.7 parts of water or 6.4 parts of the glycerose liquor and 29.0 parts water. The ingredients were blended with an electric mixer, spread on paper and allowed to dry under ambient conditions for three weeks. Formation of a brown color was noticeable but not strong. The resulting feed product was sent to the FARME Institute for a 16 hour in situ protein degradation evaluation. RUP increased from 30.7 to 72.4 percent of crude protein. The control sample treated only with water had an RUP of 37.0. Reacting the glycerose and fodder at ambient temperature greatly simplifies the generation of RUP and greatly reduces the required capital investment. For example, this approach could be used to convert soybean meal to bypass protein in a flat storage facility.

### EXAMPLE 11

### Protein and Lipid Protection in Roasted Beans

Raw soybeans (Heartland Coop, Athens, Wis.) were ground in a coffee mill and screened to save the portion that passed a 4.76 mm ( 3/16 in) circular-hole sieve while being retained on a U.S. No. 10 sieve. The hulls were partially removed by mild aeration. The resulting comminuted beans were split into two equal portions of 280 g each. One portion was treated with 5.6 g of glycerose liquor containing 20.6% glycerose equivalents on a liquid basis. The second portion was treated with 2.8 g of water. Both portions were roasted in a 150° C. convection oven for varying roasting times, using 90 g bean portions spread across the base of a preheated 20 cm diameter aluminum cake pan. Browning was observed. The roasted beans were weighed and allowed to cool under ambient conditions, then sent to the FARME Institute for in situ determination of crude protein, RUP, fat and RUF. The results are shown below in Table 9:

TABLE 9
Protein and Lipid Protection

| | Treatment, g | | Roasting | | | | |
|---|---|---|---|---|---|---|---|
| | | Glycerose | Time, | FARME Analysis, % | | | |
| Run No. | Water | Liquor | min. | CP | RUP | Fat | RUF |
| 11-1 | 2.8 | | 20 | 42.3 | 35.8 | 22.5 | 35.9 |
| 11-2 | 2.8 | | 40 | 42.1 | 46.9 | 22.6 | 44.9 |
| 11-3 | 2.8 | | 60 | 42.0 | 50.1 | 22.7 | 46.1 |
| 11-4 | | 5.6 | 10 | 42.6 | 34.8 | 23.2 | 36.0 |
| 11-5 | | 5.6 | 20 | 42.2 | 47.3 | 22.6 | 49.8 |
| 11-6 | | 5.6 | 30 | 42.1 | 55.3 | 23.3 | 50.4 |

The results in Table 9 show that protein and lipid protection was obtained for roasted soybeans. Some protection could be achieved using heat and water alone, but application of approximately one percent glycerol-based molecules onto the soybeans cut the required time approximately in half. This reduction in heating time may also reduce the amount of protein that might be damaged in the heating process.

Lignosulfonate liquors have also been used to brown soybeans, using for example about 5 wt. % lignosulfonate liquor based on the soybean weight. This represents a substantial addition of a wet, sticky material, and typically causes the soybeans to cake into a solid mass if they are not continuously agitated. Glycerose liquor can be applied at a much lower level, e.g. at about 1 wt. %. The glycerose liquor is also less viscous, easier to apply, and spreads over the beans more evenly than is the case when using lignosulfonate liquors.

### EXAMPLE 12

### Amino Acid Evaluation

One hundred grams of a biodiesel-derived glycerol waste stream containing 80% glycerol obtained from Minnesota Soybean Processors and 1.75 g of a 40% tetrasodium EDTA solution (DISSOLVINE™ E-39, Akzo Nobel) were added to a round bottom flask equipped with a magnetic stirrer. Ferrous sulfate heptahydrate (0.5 g) was dissolved in 3 mL of warm water and the resulting solution was added to the flask. The temperature of the reaction mixture was recorded and 1 mL hydrogen peroxide (35%) was added to the reaction flask using a burette. The temperature was thereafter recorded at one minute intervals, and additional 1 mL increments of hydrogen peroxide were added at five minute intervals. At t=25 minutes a cool water bath was placed around the flask and the hydrogen peroxide addition rate was increased to 1 mL/min. until 44.3 mL (50 g) hydrogen peroxide had been added. The temperature was then recorded at 5 minute intervals while the reaction proceeded and then cooled. A portion of the resulting glycerose liquor (Liquor M) was analyzed using the general method of Example 1 to determine the reducing sugar content, but replacing the Example 1 glucose standard with standards containing 100 mg/500 mL and 130 mg/500 mL glucose.

Using the method of Example 2, SBM was combined with sufficient water and Liquor M to provide a 20% moisture content and 0, 1 or 2% Liquor M as a percent of DM. After mixing, the samples were heated in a microwave oven for one minute and then transferred to a 105° C. oven to maintain the heat for total heating times of 10 or 30 minutes for the treated samples and up to 3 hours for untreated soybean meal. Some runs were measured to determine the treatment solution pH, and in run 12-9 the pH was raised from 2.97 to 4.46 via the addition of 0.13 g 5N NaOH. The samples were spread on paper to cool and dry. The samples were split and a portion sent to the FARME Institute for a 16 hour in situ protein degradation evaluation, the results of which are shown below in Table 10. A comparison sample was prepared by treating SBM with spent sulfite liquors (NORLIG™ A from LignoTech USA, Inc.) at 4% of DM using a 30 minute heating time, similarly analyzed at the FARME institute, and found to contain 65.6 RUP as a percent of CP.

The remaining portions were sealed in plastic bags and stored at room temperature. Samples prepared from Run Nos. 12-1, 12-6, 12-7 and the comparison sample were sent to the New Jersey Feed Lab, Inc. (Trenton, N.J.) for an amino acid analysis, the results of which are shown below in Table 11. The values for RUP Lysine are calculated by multiplying the measure percent Lysine times the RUP value.

TABLE 10
Feed Treatments and Protein Evaluations

| | | | | Roasting | | |
|---|---|---|---|---|---|---|
| Run | Glycerose | Water, | Dosage, | Time, | | RUP, % of |
| No. | Liquor, g | g | % of DM | min. | pH | CP |
| 12-1 | | 31.7 | 0 | 0 | | 36.7 |
| 12-2 | | 31.7 | 0 | 10 | | 32.3 |
| 12-3 | | 31.7 | 0 | 30 | | 44.7 |
| 12-4 | | 31.7 | 0 | 60 | | 44.5 |
| 12-5 | | 31.7 | 0 | 120 | | 57.9 |
| 12-6 | | 31.7 | 0 | 180 | | 65.6 |
| 12-7 | 2.94 | 30.6 | 1 | 10 | 2.97 | 72.1 |
| 12-9 | 2.94 | 30.6 | 1 | 10 | 4.46 | 80.5 |
| 12-8 | 2.94 | 30.6 | 1 | 30 | 2.98 | 71.4 |
| 12-10 | 5.93 | 30.6 | 2 | 10 | | 76.5 |

TABLE 11
Amino Acid Profile

| | Run No. | | | Comparison |
|---|---|---|---|---|
| | 12-1 | 12-6 | 12-7 | Sample |
| Treatment | Water | Water | Liquor M | NORLIG A |
| Dosage, % DM | 0 | 0 | 1 | 4 |
| Roasting Time | None | 3 hrs. | 10 min. | 30 min. |
| RUP, % of CP | 36.7 | 65.6 | 72.1 | 65.9 |

Amino acid, % as fed

| | | | | |
|---|---|---|---|---|
| Lysine | 3.06 | 2.91 | 2.96 | 2.79 |
| Phenyalanine | 0.91 | 1.02 | 0.98 | 0.99 |
| Leucine | 3.32 | 3.43 | 3.39 | 3.25 |
| Isoleucine | 1.67 | 1.78 | 1.81 | 1.72 |
| Threonine | 1.98 | 2.03 | 2.05 | 1.96 |
| Valine | 1.64 | 1.85 | 1.95 | 1.95 |
| Histidine | 1.28 | 1.29 | 1.30 | 1.21 |
| Arginine | 3.70 | 3.58 | 3.54 | 3.48 |
| Glycine | 2.32 | 2.20 | 2.18 | 2.11 |
| Aspartic Acid | 6.26 | 6.12 | 6.14 | 5.92 |
| Serine | 2.96 | 2.97 | 2.92 | 2.83 |
| Glutamic Acid | 9.31 | 9.41 | 9.56 | 8.87 |
| Proline | 2.65 | 2.66 | 2.61 | 2.58 |
| Hydroxyproline | 0.17 | 0.01 | 0.08 | 0.17 |
| Alanine | 2.41 | 3.02 | 2.94 | 2.72 |
| Tyrosine | 1.34 | 1.43 | 1.41 | 1.34 |
| Total | 45.0 | 45.7 | 45.8 | 43.9 |
| RUP Lysine, % | 1.12 | 1.91 | 2.13 | 1.84 |

The results in Table 10 show that RUP increased somewhat as heating time was increased from 10 to 30 minutes. RUP results were satisfactory at a lower pH level (2.9) and at an increased pH level (4.7) showed some improvement. Comparison of the RUP results obtained using Liquor M to results obtained using similarly-prepared glycerose samples which had been stored for 3 months prior to mixing with SBM showed that the stored glycerose liquors increased SBM RUP levels to a comparable extent.

The results in Table 11 and comparison of Run No. 12-1 (water, 10 minute roasting time) to Run No. 12-7 (1% glycerose, 10 minute roasting time showed that RUP increased from 36.7 to 72.1 while the percent lysine changed very little, from 3.06 to 2.96. Glycerose treatment increased the amount of lysine that could escape the rumen (RUP Lysine) from 1.12 to 2.13%. Glycerose treatment provided better RUP and better lysine delivery than treatment with spent sulfite liquors at 4% of DM, heat only, or no treatment.

Having thus described the preferred embodiments of the present invention, those of skill in the art will readily appreciate that the teachings found herein may be applied to yet other embodiments within the scope of the claims hereto attached. The complete disclosures of all patents, patent documents, and publications are incorporated herein by reference as if individually incorporated.

We claim:

1. A method for making a rumen undegradable protein-containing feed product, which method comprises the step of combining at least one partial oxidation product of glycerol with a protein-containing fodder or fodder precursor.

2. A method according to claim 1 wherein the partial oxidation product comprises glycerose.

3. A method according to claim 1 wherein the partial oxidation product comprises glycerose liquor containing glycerose and other side products of a glycerol oxidation reaction.

4. A method according to claim 3 wherein the glycerose liquor comprises partially oxidized crude glycerin obtained as a side product of biodiesel manufacture.

5. A method according to claim 1 wherein the partial oxidation product contains about 0.25 to about 6 wt. % glycerose based on a dry weight of the fodder or fodder precursor.

6. A method according to claim 1 wherein the partial oxidation product contains about 0.25 to about 4 wt. % glycerose based on a dry weight of the fodder or fodder precursor.

7. A method according to claim 1 wherein the partial oxidation product contains about 0.25 to about 2 wt. % glycerose based on a dry weight of the fodder or fodder precursor.

8. A method according to claim 1 wherein the fodder or fodder precursor comprises soybean meal.

9. A method according to claim 1 wherein the fodder or fodder precursor comprises canola meal.

10. A method according to claim 1 wherein the fodder or fodder precursor comprises seeds or meals from cotton, flax, mustard, peanut, safflower, sesame or sunflower plants, byproduct protein feedstuffs such as distillers or brewers grains, corn gluten meal, wheat gluten, milk products, poultry meal or fish meal.

11. A method according to claim 1 wherein the fodder or fodder precursor comprises cracked or crushed oilseed bodies and the feed product contains ruminally inert lipid(s).

12. A method according to claim 1 wherein the fodder or fodder precursor comprises soybean oil cake.

13. A method according to claim 1 further comprising mixing the partial oxidation product and fodder or fodder precursor.

14. A method according to claim 1 further comprising combining the partial oxidation product of glycerol and fodder or fodder precursor at ambient temperature.

15. A method according to claim 1 further comprising heating the partial oxidation product and fodder or fodder precursor to a temperature between about 20 and about 130° C.

16. A method according to claim 1 further comprising heating the partial oxidation product and fodder or fodder precursor to a temperature between about 20 and about 100° C.

17. A method according to claim 1 further comprising heating the partial oxidation product and fodder or fodder precursor using steam.

18. A method according to claim 1 further comprising heating the partial oxidation product and fodder or fodder precursor for less than about 45 minutes.

19. A method according to claim 1 comprising mixing the partial oxidation product and fodder or fodder precursor in an extruder or pelletizer and heating the resulting mixture using the frictional heat of mixing.

20. A method according to claim 1 wherein the fodder or fodder precursor comprises oilseeds having seed cuticles, and further comprising mechanically breaking the seed cuticles to provide oilseed bodies containing lipid(s).

21. A method according to claim 20 comprising drying the oilseed bodies and then combining the dried oilseed bodies with the partial oxidation product.

22. A method according to claim 1 wherein the feed product undergoes a browning reaction.

23. A method according to claim 1 wherein rumen degradable protein in the feed product is reduced by at least 25% compared to rumen degradable protein in the fodder or fodder precursor.

24. A method according to claim 1 wherein rumen degradable protein in the feed product is reduced by at least 50% compared to rumen degradable protein in the fodder or fodder precursor.

25. A method according to claim 1 wherein the feed product contains at least about 50% rumen undegradable protein as a percent of crude protein.

26. A method according to claim 1 wherein the feed product contains at least about 60% rumen undegradable protein as a percent of crude protein.

27. A method according to claim 1 wherein the feed product contains at least about 70% rumen undegradable protein as a percent of crude protein.

28. A ruminant feed product comprising a rumen undegradable protein-containing reaction product of one or more partial oxidation products of glycerol and a protein-containing fodder or fodder precursor.

29. A feed product according to claim 28 wherein the partial oxidation product comprised glycerose.

30. A feed product according to claim 28 wherein the fodder or fodder precursor comprised soybean meal.

31. A feed product according to claim 28 wherein the fodder or fodder precursor comprised canola meal.

32. A feed product according to claim 28 wherein the fodder or fodder precursor comprised seeds or meals from cotton, flax, mustard, peanut, safflower, sesame or sunflower plants, byproduct protein feedstuffs such as distillers or brewers grains, corn gluten meal, wheat gluten, milk products, poultry meal or fish meal.

33. A feed product according to claim 28 wherein the fodder or fodder precursor comprised cracked or crushed oilseed bodies and the feed product contains ruminally inert lipid(s).

34. A feed product according to claim 33 wherein the oilseed bodies comprise soybean bodies.

35. A feed product according to claim 28 wherein the feed product has undergone a browning reaction.

36. A feed product according to claim 28 wherein rumen degradable protein in the feed product is reduced by at least 25% compared to rumen degradable protein in the fodder or fodder precursor.

37. A feed product according to claim 28 wherein rumen degradable protein in the feed product is reduced by at least 50% compared to rumen degradable protein in the fodder or fodder precursor.

38. A feed product according to claim 28 wherein the feed product contains at least about 50% rumen undegradable protein as a percent of crude protein.

39. A feed product according to claim 28 wherein the feed product contains at least about 60% rumen undegradable protein as a percent of crude protein.

40. A feed product according to claim 28 wherein the feed product contains at least about 70% rumen undegradable protein as a percent of crude protein.

41. A feed product according to claim 28 wherein the feed product is pelletized.

42. A feed product according to claim 28 further comprising at least one added nutrient, medication, mineral or vitamin.

43. A method for feeding a ruminant, which method comprises the step of feeding to the ruminant a rumen undegradable protein-containing reaction product of one or more partial oxidation products of glycerol and a protein-containing fodder or fodder precursor.

44. A method according to claim 43 wherein the partial oxidation product comprised glycerose.

45. A method according to claim 43 wherein the fodder or fodder precursor comprised soybean meal.

46. A method according to claim 43 wherein the fodder or fodder precursor comprised canola meal.

47. A method according to claim 43 wherein the fodder or fodder precursor comprised seeds or meals from cotton, flax, mustard, peanut, safflower, sesame or sunflower plants, byproduct protein feedstuffs such as distillers or brewers grains, corn gluten meal, wheat gluten, milk products, poultry meal or fish meal.

48. A method according to claim 43 wherein the fodder or fodder precursor comprised cracked or crushed oilseed bodies and the feed product contains ruminally inert lipid(s).

49. A method according to claim 48 wherein the oilseed bodies comprise soybean bodies.

50. A method according to claim 43 wherein the reaction product has undergone a browning reaction.

51. A method according to claim 43 wherein rumen degradable protein in the reaction product is reduced by at least 25% compared to rumen degradable protein in the fodder or fodder precursor.

52. A method according to claim 43 wherein the reaction product contains at least about 50% rumen undegradable protein as a percent of crude protein.

53. A method according to claim 43 wherein the reaction product further comprises at least one added nutrient, medication, mineral or vitamin.

54. A method according to claim 43 wherein the ruminant is a dairy cow.
